(19) United States
(12) Patent Application Publication
(10) Pub. No.: US 2025/0237303 A1
(43) Pub. Date: Jul. 24, 2025

(54) DRIVETRAIN ASSEMBLY FOR A WORK VEHICLE

(71) Applicant: DEERE & COMPANY, MOLINE, IL (US)

(72) Inventors: BRADLEY A. MERRILL, DIKE, IA (US); RYAN A. HARMS, PARKERSBURG, IA (US); KEVIN R. KING, BETTENDORF, IA (US); ANDREW T. STERLING, CEDAR FALLS, IA (US)

(21) Appl. No.: 18/421,122

(22) Filed: Jan. 24, 2024

(51) Int. Cl. F16H 57/04; F16H 57/029

(52) U.S. Cl. CPC F16H 57/043; F16H 57/029

(57) ABSTRACT

A drivetrain assembly for a work vehicle includes a tube enclosing a rotatable shaft, a first seal positioned between a first end of the tube and a first housing a first gearbox, and a second seal positioned between a second end of the tube and a second housing of a second gearbox. The tube forms a sealed enclosure for fluid to flow between the first gearbox and the second gearbox.

### FIELD OF THE DISCLOSURE

The present disclosure relates to a drivetrain assembly for a work vehicle.

### BACKGROUND

Work vehicles include drivetrains, which couple a power source, such as an internal combustion engine, to one or more wheels or track assemblies. Drivetrains can include one or more sets of gears to transmit torque from the power source to the wheels or track assemblies. During operation, a pump circulates oil through a distribution circuit providing lubrication to rotating components such as shafts, gears, clutches, and axles.

### SUMMARY

According to an aspect of the present disclosure, a drivetrain assembly for a work vehicle includes a tube enclosing a rotatable shaft, a first seal positioned between a first end of the tube and a first housing of a first gearbox, and a second seal positioned between a second end of the tube and a second housing of a second gearbox. The tube forms a sealed enclosure for fluid to flow between the first gearbox and the second gearbox.

According to an aspect of the present disclosure, the first end of the tube is fixed to the first gearbox, and the second end of the tube can move axially with respect to the second gearbox.

According to an aspect of the present disclosure, a first end of the tube can move axially with respect to the first gearbox, and a second end of the tube can move axially with respect to the second gearbox.

According to an aspect of the present disclosure, the tube includes a flared end fixed to the first gearbox, and the first seal is positioned between a raised portion of the tube and the first gearbox.

According to an aspect of the present disclosure, the tube includes a disk limiting axial movement towards the second gearbox, and the second seal is positioned between the disk and the second gearbox.

According to an aspect of the present disclosure, the first end of the tube is positioned in an opening of the first housing, and the first seal is positioned between an exterior surface of the tube and the first housing.

According to an aspect of the present disclosure, the opening of the first housing includes a step limiting axial movement of the first end of the tube.

According to an aspect of the present disclosure, a retainer positioned in the opening of the second housing limits axial movement of the second end of the tube.

According to an aspect of the present disclosure, the first end of the tube is positioned around a projection extending outward from the housing, and the first seal is positioned between an interior surface of the tube and the projection.

According to an aspect of the present disclosure, the rotatable shaft includes a first internal duct arranged in a longitudinal direction and a second internal duct arranged in a transverse direction in fluid communication with the first internal duct.

According to an aspect of the present disclosure, a drivetrain assembly for a work vehicle includes a first gearbox having a first housing, a second gearbox having a second housing, a first rotatable shaft extending between the first and second gearboxes, a first tube enclosing the first rotatable shaft, a first seal and a second seal positioned between the first tube and the first housing, the first tube forming a sealed enclosure for fluid to flow from the first housing to the second housing, and the first housing including a duct between the first and second seals, which separate the duct from the first tube, and a removable plug positioned in an end of the duct, the removable plug sealing the duct.

According to an aspect of the present disclosure, the drivetrain assembly includes a second rotatable shaft extending between the first and second gearboxes, a second tube enclosing the second rotatable shaft, and a third seal and a fourth seal positioned between the second tube and a first housing. The second tube forms a sealed enclosure for fluid to flow from the first housing to the second housing. The duct extends from between the first and second seals to between the third and fourth seals, which separate the duct from the first and second tubes.

According to an aspect of the present disclosure, a first end of the first tube can move axially with respect to the first housing, and a second end of the first tube can move axially with respect to the second housing.

According to an aspect of the present disclosure, a first end of the second tube can move axially with respect to the first housing, and a second end of the second tube can move axially with respect to the second housing.

According to an aspect of the present disclosure, a first end of the first tube is positioned in a first opening of the first housing, and the second end of the first tube is positioned in a first opening of the second housing.

According to an aspect of the present disclosure, a first end of the second tube is positioned in a second opening of the first housing, and the second end of the second tube is positioned in a second opening of the second housing.

According to an aspect of the present disclosure, the first opening of the first housing includes a first step limiting axial movement of the first end of the first tube.

According to an aspect of the present disclosure, a first retainer positioned in the first opening of the second housing limits axial movement of the second end of the first tube.

According to an aspect of the present disclosure, the second opening of the first housing includes a second step limiting axial movement of the first end of the second tube.

According to an aspect of the present disclosure, a second retainer positioned in the second opening of the second housing limits axial movement of the second end of the second tube.

The above and other features will become apparent from the following detailed description and accompanying drawings.

### BRIEF DESCRIPTION OF THE DRAWINGS

The detailed description refers to the accompanying figures in which:

FIG. 1 is a perspective view of a work vehicle, according to an implementation;

FIG. 2 is a schematic view of a drivetrain assembly, according to an implementation;

FIG. 3 is a cross-sectional view of a drivetrain assembly, according to an implementation;

FIG. 4 is a cross-sectional view of a drivetrain assembly, according to an implementation;

FIG. 5 is a cross-sectional view of a drivetrain assembly, according to an implementation;

FIG. 6 is a cross-sectional view of a drivetrain assembly, according to an implementation;

FIG. 7 is a cross-sectional view of a drivetrain assembly, according to an implementation;

FIG. 8 is a cross-sectional view of a drivetrain assembly, according to an implementation; and

FIG. 9 is a cross-sectional view of a drivetrain assembly, according to an implementation.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

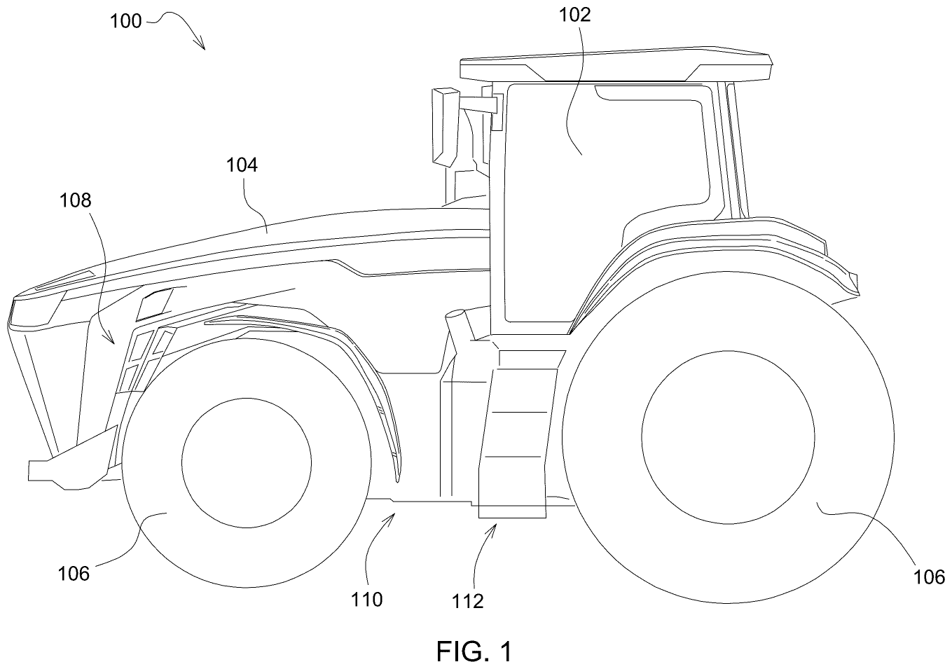

With reference to FIG. 1, a work vehicle 100, for example an agricultural tractor, can include an operator station or cab 102, a hood 104, one or more ground engaging apparatus 106, for example wheels or track assemblies, and a frame or chassis 110. The work vehicle 100 can include an operator interface having any number and combination of electronic devices, such as an interactive display. The work vehicle 100 can have a rigid or an articulated frame 110. The work vehicle 100 can include one or more power sources 108, for example an internal combustion engine, a hybrid engine, or an electric or hydraulic machine. The work vehicle 100 can include a drivetrain 112 transferring power from the one or more power sources 108 to one or more ground engaging apparatus 106 and one or more power take off (PTO) shafts or other auxiliary power outputs or inputs. The drivetrain 112 can include a transmission and one or more gearboxes. This disclosure also applies to other types of work vehicles in agriculture, construction, forestry, and road building.

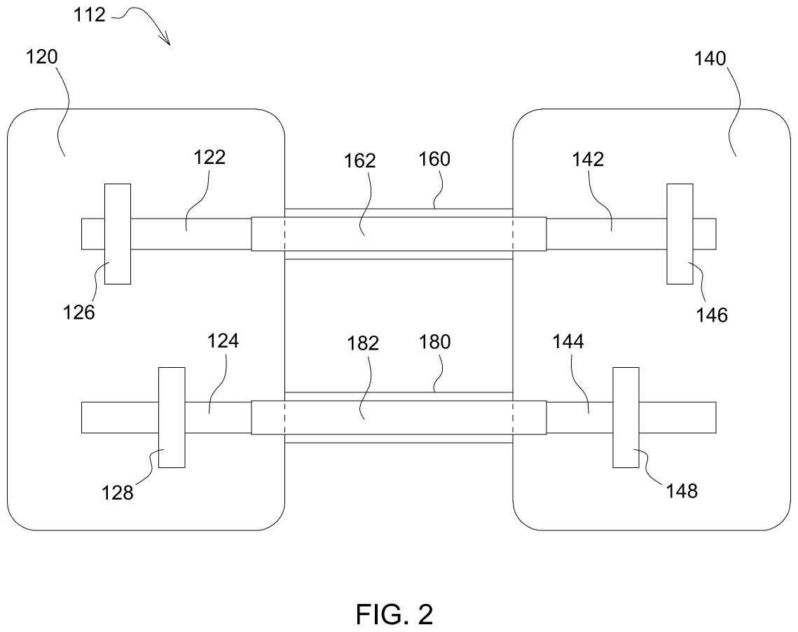

With reference to FIGS. 2-9, a drivetrain 112 can include one or more gearboxes 120, 140. Each of the gearboxes 120, 140 can include one or more shafts 122, 124, 142, 144 with each shaft including one or more gears 126, 128, 146, 148. In some implementations, any of the gears 126, 128, 146, 148 can be connected or attached directly to the shafts 162, 182 extending between the gearboxes 120, 140. Each gearbox 120, 140 can include bushings and bearings to support the rotating shafts, gears, and other components. A tube 160 can surround or enclose a shaft 162 extending between the gearboxes 120, 140. A tube 180 can surround or enclose a shaft 182 extending between the gearboxes 120, 140. Each of the tubes 160, 180 can form a sealed conduit or channel between the gearboxes 120, 140. One or more seals can be positioned between the ends of the tubes 160, 180 and the gearboxes 120, 140. Fluid can flow between the gearboxes 120, 140 through the tubes 160, 180. Fluid can flow between the walls of the non-rotating tubes 160, 180 and the rotating shafts 162, 182.

Each tube 160, 180 can move axially relative to one of or both the gearboxes 120, 140. In some implementations, one end of each tube 160, 180 can be fixed to one of the gearboxes 120, 140 and other end of each tube 160, 180 can move axially relative to the other gearbox. In other implementations, the tubes 160, 180 can move axially relative to both gearboxes 120, 140. Each of the tubes 160, 180 forms a sealed enclosure for fluid to flow between the gearboxes 120, 140. Each of the tubes 160, 180 can include one or more seals at each end positioned between the tubes 160, 180 and the gearboxes 120, 140.

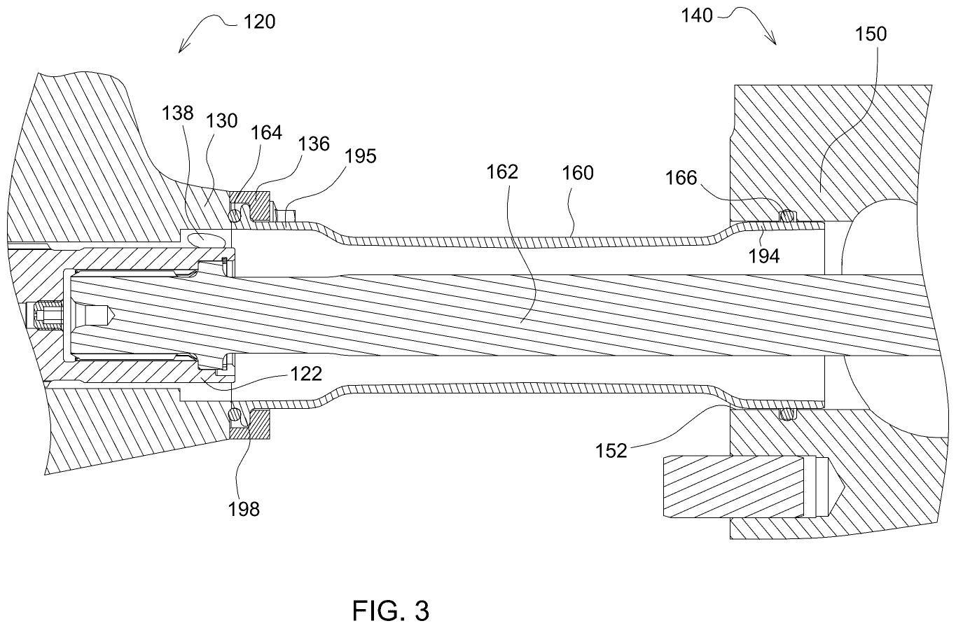

A non-rotating tube 160 encloses a rotating shaft 162 extending between the gearboxes 120, 140, as shown for example in FIGS. 3-9. The tube 160 can be fixed to gearbox 120 at one end, as shown for example in FIG. 3. The tube 160 can be connected to the housing 130 of the gearbox 120 with one or more fasteners, a flange, or other retention apparatus 136. A seal 164 can be positioned between a raised portion 198 of the tube 160 and the housing 130. In some implementations, a plurality of seals 164 can be positioned between a raised portion 198 of the tube 160 and the housing 130. The tube 160 can include a widened or flared end 195 positioned adjacent to the housing 130. The other end of the tube 160 can have relative movement to the gearbox 140 in the axial direction. The tube 160 can include a widened or flared end 194 positioned in the opening 152 in the housing 150. A seal 166 can be positioned between the widened or flared end 194 and the housing 150. The seal 166 can be positioned in the opening 152 between an exterior surface of the tube 160 and the housing 150. The seal 166 can be an axial or radial seal. In some implementations, a plurality of seals 166 can be positioned between the widened or flared end 194 and the housing 150.

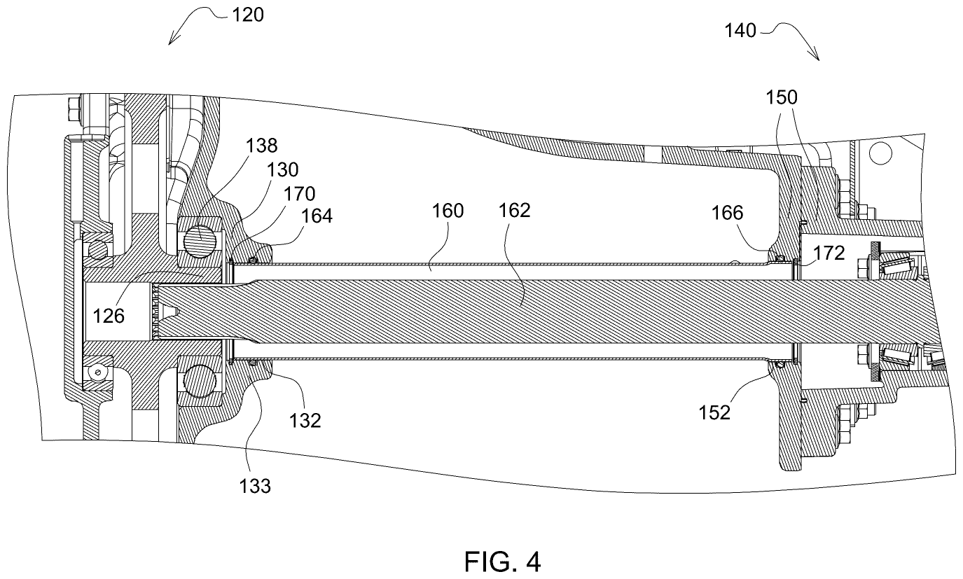

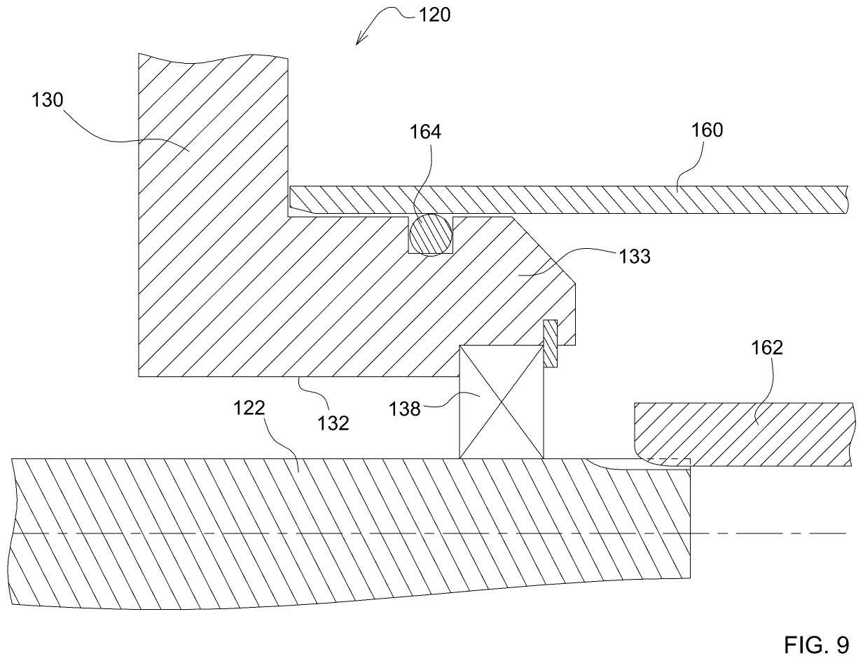

The tube 160 can have relative movement to both gearboxes 120, 140 in the axial direction, as shown for example in FIGS. 4-9. The tube 160 can extend into an opening 132 in the housing 130. A seal 164 can be positioned between the tube 160 and the housing 130. The seal 164 can be positioned in the opening 132 between an exterior surface of the tube 160 and the housing 130, as shown for example in FIGS. 4-8. The tube 160 can be positioned inside or outside a projection 133 extending outward from the housing 130. The tube 160 can be positioned around the projection 133, as shown for example in FIG. 9. The seal 164 can be positioned between an interior surface of the tube 160 and the projection 133 of the housing 130. The seal 164 can be an axial or radial seal. In some implementations, a plurality of seals 164 can be positioned between the tube 160 and the housing 130. The shaft 162 can connect or attach to a shaft 122, a gear 126, or both inside the gearbox 120. A bushing or bearing 138 can support any combination of the shaft 162, the shaft 122, and the gear 126.

The tube 160 can extend into an opening 152 in the housing 150 of the gearbox 140. A seal 166 can be positioned between the tube 160 and the housing 150. The seal 166 can be positioned between an exterior surface or an interior surface of the tube 160 and the housing 150. In some implementations, a plurality of seals 166 can be positioned between the tube 160 and the housing 150. A bushing or bearing 156 can support any combination of the rotating shaft 162, the shaft 142, and the gear 148. A retainer or retention ring 170 can limit the axial movement of the tube 160 into the housing 130 of the gearbox 120. A retainer or retention ring 172 can limit the axial movement of the tube 160 into the housing 150 of the gearbox 140. The retainer 170 can limit the movement in a first axial direction and the retainer 172 can limit the movement in an opposite second axial direction.

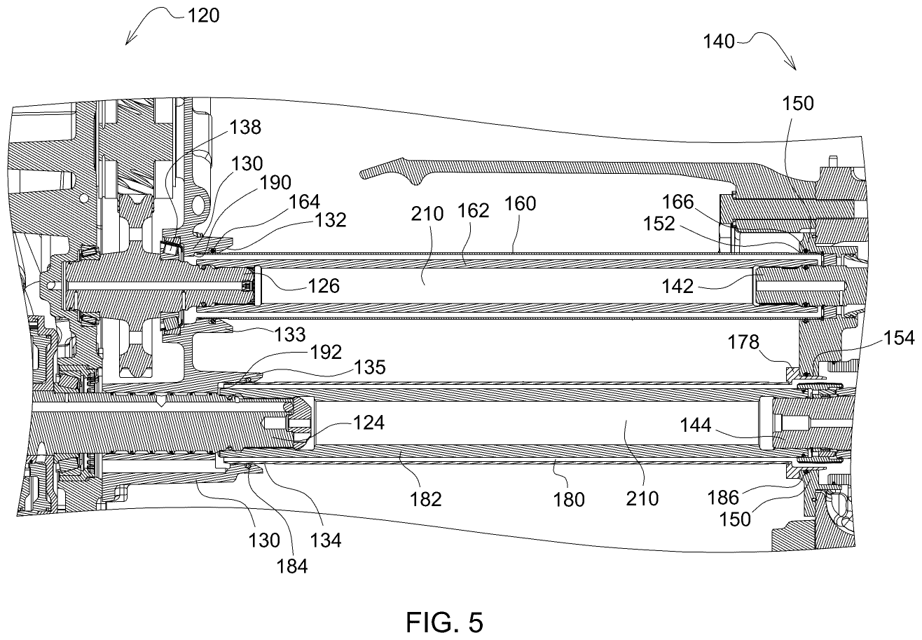

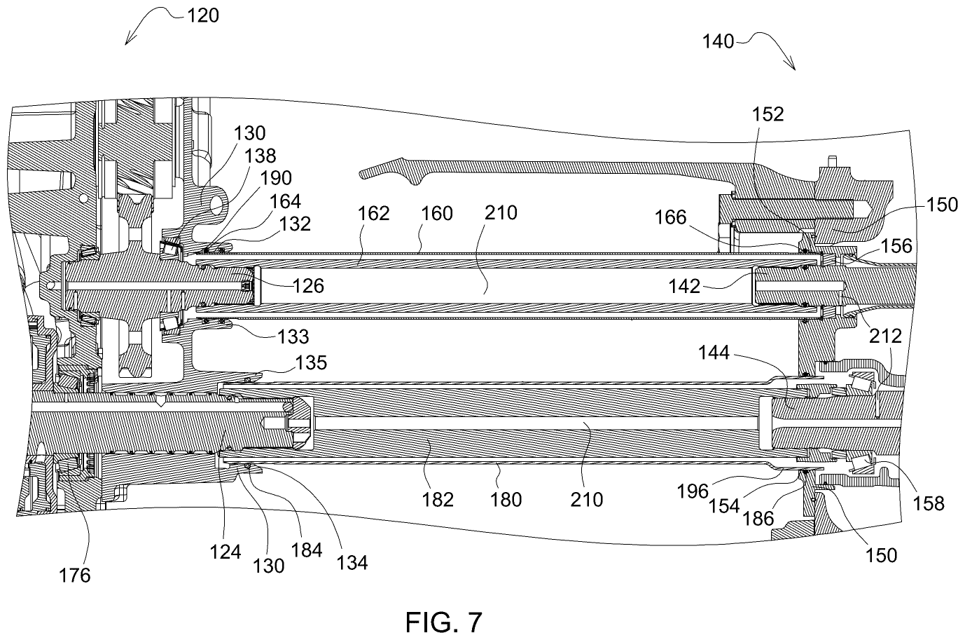

A non-rotating tube 180 encloses a rotating shaft 182 extending between the gearboxes 120, 140, as shown for example in FIGS. 5 and 7. The tube 180 can be fixed to one of the gearboxes and have relative movement in the axial direction to the other gearbox, or the tube 180 can have relative movement to both gearboxes 120, 140 in the axial direction. The tube 180 can extend into an opening 134 in the housing 130. The tube 180 can be positioned inside or outside a projection 135 extending outward from the housing 130. A seal 184 can be positioned between the tube 180 and the housing 130. The seal 184 can be positioned in the opening 134 between the tube 180 and the housing 130. The seal 184 can be positioned between an exterior or interior surface of the tube 180 and the housing 130. The seal 184 can be an axial or radial seal. In some implementations, a plurality of seals 184 can be positioned between the tube 180 and the housing 130. The housing 130 can include a step or landing 190, which limits the axial movement of the tube 160 into the housing 130. The housing 130 can include a step or landing 192, which limits the axial movement of the tube 180 into the housing 130. The shaft 182 can connect or attach to a shaft 124, a gear 128, or both inside the gearbox 120.

The tube 180 can extend into an opening 154 in the housing 150 of the gearbox 140. A seal 186 can be positioned between the tube 180 and the housing 150. The seal 186 can be positioned in the opening 154 between the tube 180 and the housing 150. The seal 186 can be positioned between an exterior or interior surface of the tube 180 and the housing 150. The seal 186 can be an axial or radial seal. In some implementations, a plurality of seals 186 can be positioned between the tube 180 and the housing 150. The tube 180 can include a ring or disk 178, which limits the axial movement of the tube 180 into the housing 150, as shown for example in FIG. 5. The ring or disk 178 can be separate from or integral with the tube 180. The tube 180 can include a widened or flared end 196 positioned in the opening 154 in the housing 150. The shaft 182 can connect or attach to a shaft 144 or gear 148 inside the gearbox 140. A bushing or bearing 158 can support the rotating shaft 182, the shaft 144, or both, as shown for example in FIG. 7.

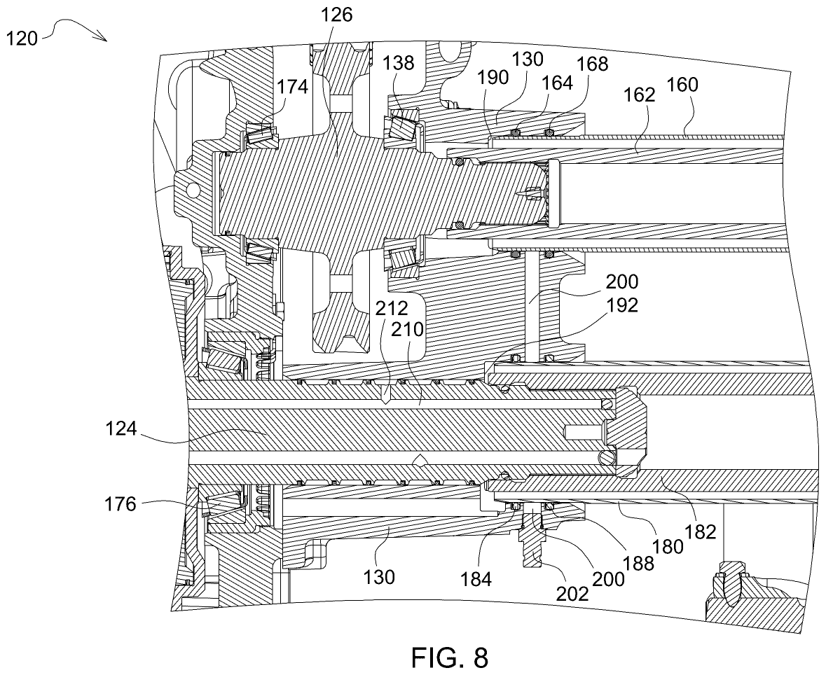

The rotating shaft 162 can connect or attach to the gear 126 in gearbox 120, as shown for example in FIG. 8. Two bearings 138 and 174 can support the gear 126. A bearing 176 supports the shaft 124. The housing 120 can include a duct 200 between the seals 184, 188 and between the seals 164, 168. The duct 200 is separate or isolated from fluid flowing between the gearboxes 120, 140 through the tubes 160, 180. The duct 200 can include a different fluid than the fluid in the tubes 160, 180. The plug 202 is selectively removable from an end of the duct 200. The plug 202 seals the duct 200 from the atmosphere. The plug 202 can include a seal, for example an O-ring, to seal the duct when the plug 202 is installed in the duct 200. When the plug 202 is removed from the duct 200, a fluid, for example compressed air, can be introduced into the duct 200 to test or assess the status or condition of the seals 164, 168, 184, 188.

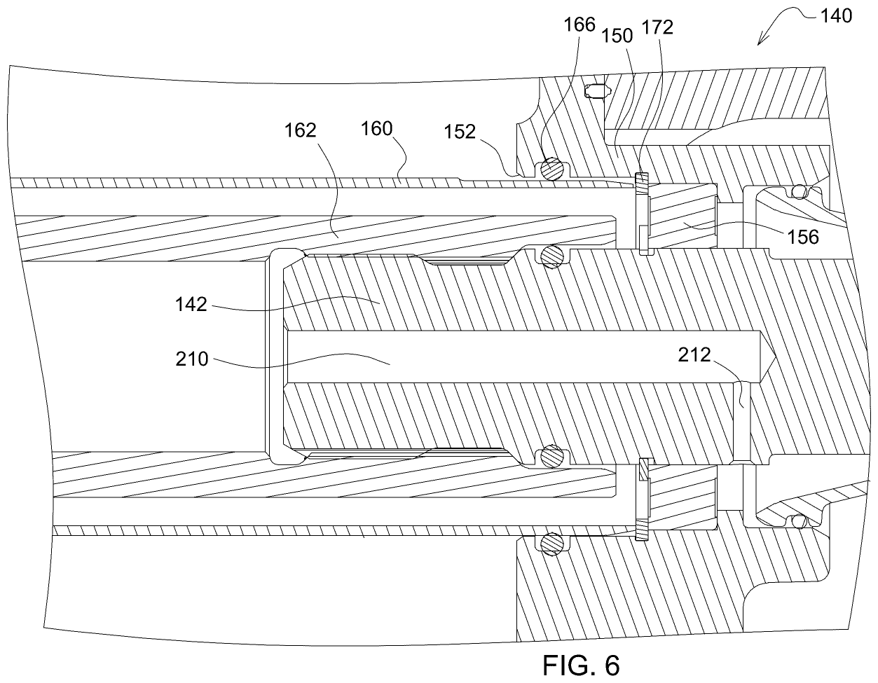

Any of the shafts 122, 124, 142, 144, 162, 182 can include one or more internal passages or ducts 210 arranged longitudinal or parallel, as shown for example in FIGS. 5-8. These internal passages or ducts 210 can either be isolated from or in fluid communication with the fluid between the walls of the tubes 160, 180 and the shafts 162, 182. These internal passages or ducts 210 can either include the same fluid or a different fluid than the fluid between the walls of the tubes 160, 180 and the shafts 162, 182. Any of the shafts 122, 124, 142, 144, 162, 182 can also include one or more internal passages or ducts 212 arranged transverse or perpendicular, as shown for example in FIGS. 6-8.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drivetrain assembly for a work vehicle, comprising:
a tube enclosing a rotatable shaft;
a first seal positioned between a first end of the tube and a first housing of a first gearbox; and
a second seal positioned between a second end of the tube and a second housing of a second gearbox, the tube forming a sealed enclosure for fluid to flow between the first gearbox and the second gearbox.

2. The drivetrain assembly of claim 1, wherein the first end of the tube is fixed to the first gearbox, and the second end of the tube can move axially with respect to the second gearbox.

3. The drivetrain assembly of claim 1, wherein a first end of the tube can move axially with respect to the first gearbox, and a second end of the tube can move axially with respect to the second gearbox.

4. The drivetrain assembly of claim 1, wherein the tube includes a flared end fixed to the first gearbox, and the first seal is positioned between a raised portion of the tube and the first gearbox.

5. The drivetrain assembly of claim 1, wherein the tube includes a disk limiting axial movement towards the second gearbox, and the second seal is positioned between the disk and the second gearbox.

6. The drivetrain assembly of claim 1, wherein the first end of the tube is positioned in an opening of the first housing, and the first seal is positioned between an exterior surface of the tube and the first housing.

7. The drivetrain assembly of claim 6, wherein the opening of the first housing includes a step limiting axial movement of the first end of the tube.

8. The drivetrain assembly of claim 6, wherein a retainer positioned in the opening of the second housing limits axial movement of the second end of the tube.

9. The drivetrain assembly of claim 1, wherein the first end of the tube is positioned around a projection extending outward from the housing, and the first seal is positioned between an interior surface of the tube and the projection.

10. The drivetrain assembly of claim 1, wherein the rotatable shaft includes a first internal duct arranged in a longitudinal direction and a second internal duct arranged in a transverse direction in fluid communication with the first internal duct.

11. A drivetrain assembly for a work vehicle, comprising:
a first gearbox having a first housing;
a second gearbox having a second housing;
a first rotatable shaft extending between the first and second gearboxes;
a first tube enclosing the first rotatable shaft;
a first seal and a second seal positioned between the first tube and the first housing, the first tube forming a sealed enclosure for fluid to flow from the first housing to the second housing, and the first housing including a duct between the first and second seals, which separate the duct from the first tube; and
a removable plug positioned in an end of the duct, the removable plug sealing the duct.

12. The drivetrain assembly of claim 11, further comprising:
a second rotatable shaft extending between the first and second gearboxes;
a second tube enclosing the second rotatable shaft; and
a third seal and a fourth seal positioned between the second tube and a first housing, the second tube forming a sealed enclosure for fluid to flow from the first housing to the second housing, and the duct extending from between the first and second seals to between the third and fourth seals, which separate the duct from the first and second tubes.

13. The drivetrain assembly of claim 11, wherein a first end of the first tube can move axially with respect to the first housing, and a second end of the first tube can move axially with respect to the second housing.

14. The drivetrain assembly of claim 12, wherein a first end of the second tube can move axially with respect to the first housing, and a second end of the second tube can move axially with respect to the second housing.

15. The drivetrain assembly of claim 11, wherein a first end of the first tube is positioned in a first opening of the first housing, and the second end of the first tube is positioned in a first opening of the second housing.

16. The drivetrain assembly of claim 12, wherein a first end of the second tube is positioned in a second opening of the first housing, and the second end of the second tube is positioned in a second opening of the second housing.

17. The drivetrain assembly of claim 15, wherein the first opening of the first housing includes a first step limiting axial movement of the first end of the first tube.

18. The drivetrain assembly of claim 15, wherein a first retainer positioned in the first opening of the second housing limits axial movement of the second end of the first tube.

19. The drivetrain assembly of claim 16, wherein the second opening of the first housing includes a second step limiting axial movement of the first end of the second tube.

20. The drivetrain assembly of claim 16, wherein a second retainer positioned in the second opening of the second housing limits axial movement of the second end of the second tube.
